(19) United States
(12) Patent Application Publication
(10) Pub. No.: US 2021/0342495 A1
(43) Pub. Date: Nov. 4, 2021

(54) Garment Creation System, Method and Apparatus

(71) Applicant: Galatea Inc., Sammamish, WA (US)

(72) Inventor: Sabreen Mohammed, Sammamish, WA (US)

(73) Assignee: Galatea Inc., Sammamish, WA (US)

(21) Appl. No.: 17/243,265

(22) Filed: Apr. 28, 2021

Related U.S. Application Data
(60) Provisional application No. 63/017,461, filed on Apr. 29, 2020.

(51) Int. Cl. G06F 30/12; G06F 30/23

(52) U.S. Cl. CPC G06F 30/12; G06F 2111/04; G06F 30/23

(57) ABSTRACT

Methods, apparatus, and system to generate a garment representation for a sewn product, including to determine a product form, create a geometry according to the product form, determine a product seam, determine a product material, generate a geometry specification for the sewn product according to the product form, the product seam, and the product material, and to output the garment representation as a print file.

### CROSS-REFERENCE TO RELATED APPLICATIONS

The present application is a nonprovisional application and claims priority to provisional U.S. Patent Application No. 63/017,461, filed Apr. 29, 2020, titled “A System for Precisely and Efficiently Manufacturing Dynamically Generated Garments,” and naming Sabreen Mehvish Mohammed as inventor. The entire contents of the above-referenced applications and of all priority documents referenced in the Application Data Sheet filed herewith are hereby incorporated by reference for all purposes.

### FIELD

The present disclosure relates to one or more computing devices, in particular to, one or more computing devices to precisely and efficiently manufacture dynamically created garments.

### BACKGROUND

Turning an apparel concept into a physical garment often requires knowledge and capital that the average individual does not have. High quality manufacturing of bespoke and made-to-measure apparel is difficult to scale and provide at low costs due to its high dependence on various types and skill levels of human labor. Additionally, precise and high-fidelity translation of 2D and 3D apparel concepts in the form of sketches, CAD models, or other intuitive visual form into sewing patterns and technical specifications currently requires skilled human labor thereby making the process difficult to scale and costly.

Other 2D or 3D environments for apparel creation require training or expertise, and do not offer sophisticated support for conversion into technical specifications. Furthermore, current computer vision based apparel manufacturing systems can fabricate limited categories of apparel with a limited selection of materials and can be tooled in few ways. The absence of precise, reliable, cost-effective design and manufacturing systems limits the quality of the apparel that can be produced, especially when customization features are offered to the consumer.

### BRIEF DESCRIPTION OF THE DRAWINGS

FIG. 1 is a network and device diagram illustrating an example of a garment creation computer, a computer device datastore, a manufacturing computer device, a sewing computer and network incorporated with teachings of the present disclosure, according to some embodiments.

FIG. 2 is a functional block diagram illustrating an example of the garment creation computer of FIG. 1, incorporated with teachings of the present disclosure, according to some embodiments.

FIG. 3 is a functional block diagram illustrating an example of the computer device datastore incorporated with teachings of the present disclosure, consistent with embodiments of the present disclosure.

FIG. 4 is a flow diagram illustrating an example of a method performed by an edit design module, according to some embodiments.

FIG. 5 is a flow diagram illustrating an example of a method performed by a geometry compilation module, according to some embodiments.

FIG. 6 is a flow diagram illustrating an example of a method performed by an instruction generation module, according to some embodiments.

FIG. 7 is a diagram illustrating an example of a method performed by the garment creation computer of FIG. 1, incorporated with teachings of the present disclosure, according to some embodiments.

### DETAILED DESCRIPTION

Following are defined terms in this document.

As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures.

As used herein, a process corresponds to an instance of a program, e.g., an application program, executing on a processor and a thread corresponds to a portion of the process. A processor may include one or more execution core(s). The processor may be configured as one or more socket(s) that may each include one or more execution core(s).

In overview, this disclosure relates to a system, method, and apparatus performed by and in one or more computer device apparatus to automatically generate high-fidelity technical specifications for an apparel concept created in various types of Computer-Aided Design (CAD) environments. In embodiments, the system, method, and apparatus may generate visual or tactile representations of apparel including simulations of various fidelity, human readable step by step manuals, and machine-readable instructions (including data files, CNC programs, and machine code to print, cut, sew, plot, weave, knit, chemically or mechanically alter, chemically or biologically synthesize and embroider).

In embodiments, the system, method, and apparatus may reduce or even remove human effort in the process of transforming an apparel concept into a physical garment. The system, method, and apparatus can provide virtual environments that allow individual or collaborative product design through tasks that include virtual sculpting, cutting, joining, draping, gathering, folding, creasing, scoring, drawing, decoration, and customization of garments on a custom avatar.

In embodiments, the system, method, and apparatus may allow degrees of WYSIWYG (What you see is what you get) manipulation of apparel representations directly in their respective virtual environments, using parametric interfaces that allow modification of parameters exposed by the interface designer (including sliders for continuous product variables, drop-down lists of discretized product variables, text editors for editable parametric equations that specify product), integrated development environments that allow execution of logic at endpoints exposed by the interface designer (including tools to record and expand macros, markup editors and parsers, software development kits to facilitate programmatic design of products), and direct design environments (including cursor tools, GUI elements, input processing methods like hit-testing and raycasting, and simulation methods for applying local and global transformations to the product to accomplish design tasks like various combinations of organic modelling and constrained modelling, rigid and soft-body manipulations like folding and draping, vector and raster graphics generation.

In embodiments, the system, method, and apparatus may use graphics and simulation software to accept mathematical or logical specifications for apparel elements and their transformations and renders said elements in virtual environments. In embodiments, virtual environments validate virtual concepts with simulations, and offer a vast selection of parameterizations that allow users to conform their designs to certain styles or garment categories (e.g. shirt parameterizations, A-line skirt parameterizations).

In embodiments, the system, method, and apparatus generate a manufacturing plan by taking real-world logistical constraints and available facilities, workers, machinery, and other resources along with their corresponding specifications and status into account. Once manufacturing parameters are known, a garment representation can be compiled into instructions for a specific manufacturer, machine, and methodology that is scheduled to fabricate the digitally designed good. A garment may be represented at various levels of abstraction and may consist of a set of material surface geometry representations, seam relations, and material data. A higher level garment representation may additionally include macros that can be expanded to be incorporated into the base garment representation, such as texture, fold, and displacement maps that when applied alter the surface geometry representation to accommodate extra fullness, UV maps that when applied alter the material data specification by adding textile manufacturing and customization specifications, seam markup that when applied results in cleaving of all surface geometries along the path the seam was placed and virtual sewing along the cleaved edge, and notions markup that when expanded transforms into detailed models of the notion's surface. When further compiled down to a lower level of abstraction, the garment representation may include a fiber-level geometry specification, stitch marker data and manufacturing data.

In embodiments, a geometry may be defined in a virtual environment in terms of a boundary path or any other boundary set (e.g. bounded parametric functions, piece-wise definition of each segment of a path). In a 2D environment, a typical geometry is defined in terms of its boundaries using composite Bezier curves, beziergons, arcs, and splines. In a 3D environment, a geometry may be a Nurb surface, a polygon mesh, a representation of a primitive or elementary shape (e.g. plane, sphere) or any other representation of a surface. Seams may be edited on a geometry, such as adding a path known as a “style line” as a directive to later cleave the surface geometry along the path, removing a style line's path to rescind the corresponding directive to cleave the surface geometry along the path. As used herein, “style line” may be referred to as any path such as a spline or an arc. In embodiments, the system, method, and apparatus may allow a user to merge, blend, or otherwise compose multiple geometries. Decomposing geometries is allowed in various ways. For example, the system, method, and apparatus may sculpt a bodice, sleeves, and a skirt as separate geometries and let the user later decide to merge all the geometries into one dress. This is helpful if the user does not want the dress to have a seam where the bodice and skirt meet and may instead like to accommodate the paths through vertical seams. In this example, vertical seams may be added to various locations of the geometries after the geometries are merged.

Stitch marker data may include a stitch marker that may be a shape or path that is placed on, intersects with, points to, or otherwise refers to a point, where a needle needs to be inserted to sew the garment. Stitch marker data may include symbols that identify each marker. These symbols can take many forms, and the symbol system can be organized using many different schemas (e.g. a letter represents a unique continuous edge, and a subsequent number represents the index of the marker along that edge, symbols to represent tool settings and materials such as thread to apply to each target point). Manufacturing data may include files for cutters, embroiderers, sewing machines, robots, scanners, and other manufacturing equipment, which can be an be machine code or input at any appropriate level of abstraction. The garment representation may include print files used to put markers on the sewn good pieces (e.g. directly via a process like inkjet, or on an object that is transferred, projected, or adhered to a piece that will be sewn).

In embodiments, the system, method, and apparatus may optimize targets or collision points (such as locations for needle insertion, laser beams for laser cutting, toolheads for any plotter, nozzles for certain types of printing) by analyzing garment geometry (e.g. edge curvature, corner angles, arc lengths) and material properties (e.g. grain, knit pattern, elasticity, thread count, flammability, tensile strength, permeability, flammability). The targets are used to compute a set of assembly instructions (including grasping, moving, manipulating, composing, decomposing, transforming, calibrating, testing, and documenting) which are collated and converted to machine readable instructions, as well as instructions (e.g. automatically generated natural language instructions step-by-step instruction manual, removable sticker with labelled sewing guides and alignment markers adhered onto garment material, annotations printed directly or transferred onto material) that may be used by an unskilled individual by the system, method, and apparatus to produce a garment of comparable quality.

In embodiments, the system, method, and apparatus may check for geometries, where there do not exist a sequence of steps that can transform the geometry into a product of the specified class of embodiment (e.g. physical garment, augmented reality filter that dynamically superimposes garment on subject, cryptographic hash of garment, any other class of virtual embodiment of the product) regardless of which of the available machinery is used to manufacture it. In typical cases, the system, method, and apparatus may check for geometries that may be impossible to cut out as one whole piece (such as self-intersecting paths open paths, or lone points within the garment representation) and geometries that cannot exist within three dimensional space, irrational surfaces, and disconnected spaces.

In embodiments, the system, method, and apparatus may reduce a 3D shape or a silhouette down to the appropriate primitive and produce a geometry specification. In embodiments, the system, method, and apparatus may flatten the 3D shape into a 2D shape if the material constraints require that all output geometries must be developable surfaces or breaking pieces up into tubes. The maximum print size or full fabric width might also be considered. If a roll of twill that the customer wants is 56 inches wide, all pieces must be no wider than 56 inches at any point.

In embodiments, the system, method, and apparatus may determine the product form and product material of the garment representation from a user input. For example, because jacquard loom woven fabric is most often not rotationally symmetrical, the user can get very different looking products just by cutting the pieces at different angles from a selvage. The system, method, and apparatus may determine bias cutting for the user, where pieces are cut so that the axis that will be vertical when worn is cut at a 45-degree angle from the selvage. The bias cutting can make woven garments appear more fluid. The system, method, and apparatus may also determine, for example, how long the fabric is to be hung before the pieces are cut, or what heat is applied.

In embodiments, the garment representation may further include seam allowance representation, needle insertion markers, symbols that identify elements either for human inspection or machine sensing, print files with appropriate format for printing, embroidering, weaving, automatic cutting, and any other fabrication process (e.g. CMYK vs. RGB, vector vs. raster, resolution, etc.). In embodiments, the disclosed method may include steps to facilitate handling of a particular fabric (e.g. staystitching, stabilizer, pressing), and steps to handle finishes (e.g. raw edge finishing, serging, pressing) and addition of auxiliary elements like linings, facings, interfacings, boning, horsehair braid, wiring.

In embodiment, further modifications may be made to the existing garment representation. For example, transformations to account for material properties (e.g. scaling patterns to account for stretch, rotations to accommodate fabrics with prominent visible grains, seam or path offsetting to account for area lost due to folding bulky materials, seam or path scaling to account for anticipated shrinkage or relaxation), and transformations to increase efficiency in the context of batching orders (e.g. rotating and translating pieces in the nesting process to pack as many pieces as possible from various orders into a small area of fabric but doing so within material constraints such as naps and grainlines).

In embodiments, the system, method, and apparatus may include automatic calculation of edge pairs that create seams and automatic generation of specifications for supporting pieces (including facing, lining, interfacing pieces, wires, elastics, etc.) after each incremental edit in a WYSIWYG (What You See Is What You Get) environment.

In embodiments, the system, method, and apparatus may automatically calculate relations between pattern pieces with every incremental edit made by the user in a 2D or 3D editor. In embodiments, the system, method, and apparatus may generate instructions on how to convert these relationships into manufacturing data, machine executable instructions, and human readable instructions. In embodiments, the system, method, and apparatus may use these relationships to determine what additional components the garment ought to have (e.g. linings, facings, interfacings, wires, elastics) and optionally generates manufacturing data for these components too.

In embodiments, the garment representation produced by the system, method and apparatus may include fabric cut lines, print graphics, embroidery instructions, laser cutting instructions, and specific points at which needles should be inserted into each piece when sewing the garment. In embodiments, any design can be automatically graded to fit a different human avatar with any size, shape, density and tonicity distribution, and other anatomical and physiological characteristics, by using methods including continuous deformation within a space defined by a set of measurement-related axes, grading rules that are any combination of discrete and continuous functions with respect to measurement-related parameters, and generative neural networks that take a body representation as input and output an appropriately graded version of the garment. The precision of the technical specifications allows automatic generation of a human-readable construction manual, or generation of machine instructions in computer-vision aided sewing systems, cutters, embroiderers, and more.

In embodiments, the system, method, and apparatus may provide an integrated approach to design garment representations, generate technical specifications, and manufacture garments. In embodiments, the garment representation can be created in many ways including directly drawing paths in 2D and explicitly defining seam relations, drawing meshes in 3D and then running the 2D shape through a distortion minimizing flattening algorithm or searching a database for the closest matching existing pattern and searching for the simplest set of modifications that will transform the existing pattern into a representation that meets the constraints of the current specification.

In embodiments, the system, method, and apparatus may produce physical or virtual forms of apparel, accessories, visual artwork, augmented reality filters, stitched products, DIY (do-it-yourself) product kits, products made using 2D patterns, mass-customized products, medical devices or wear, or any combination of the above.

In embodiments, the system, method, and apparatus may be used with non-apparel products. The system, method, and apparatus may generate instructions for products that require joining multiple components into a single item, either physically or in a virtual environment. In embodiments, the system, method, and apparatus may allow the creation of designs for textile or paper items, items that are printed, sewn, cut, embellished, or decorated, virtual and augmented reality products, or 3D printed items. In embodiments, a product can be designed by creating a procedurally generated scaffolding and applying the style of input images using style transfer algorithms. In embodiments, a 3D CAD environment can adopt the disclosed method of handling 3D user interaction.

In embodiments, the system, method, and apparatus may accept user-defined measurements of a general type and a scaffolding of a garment representation to create a simple starter garment representation that fits the user. User-defined input (or user directive) may include any folds, pleats, ruffles, bloating, puckering, warping, or other feature. The system, method, and apparatus may translate these user input to changes in the garment representation with continuous deformations or complete recalculations.

For example, if a user wants a puffy sleeve, the user may select the shoulder seam on the user interface, increase a ruffle setting on said user interface, and apply it to only the sleeve side of the seam (unless the user also wants to make the yoke area puffy, which this example assumes is not the case). The system, method, and apparatus may take this simple user directive and make a series of modifications to product seam. Alternatively, the user may choose to define folds, gathers, and pleats as markup the product's surface geometry or on a UV map such as a displacement map or a texture map of sorts; the same modifications to the product seam as discussed earlier can then be derived by collecting the values on the UV map that intersect the boundary set associated with the seam. Modifications to the product seam may include a proportional scaling of the length of a sleeve cap edge and distortion of the rest of the sleeve path to ensure that all other user-defined criteria are still met. Modifications to the product seam may include a recalculation of stitch resolution on the sleeve edge. The seam may be still made with the same number of stitches, but now those stitches are wider and/or further apart on the sleeve because the edge length is longer.

The present disclosure is better than existing tools because the integration and use of automation removes overhead costs for computation, labor, and materials used. Additionally, the integration and use of automation reduces complexity to provide a superior user experience and produce precisely constructed, reliably high-quality garments.

In embodiments, the system, method, and apparatus may automatically encode apparel items made to fit a particular human avatar into a universal set of proportions and relationships. This set of relationships can be applied to a human avatar of any shape and physiology, as long as it can be topologized to fit an available parametrization or representation of the human body.

In embodiments, the disclosure relates to a method that uses machine learning algorithms such as style transfer neural networks or generative adversarial neural networks to re-appropriate photographs and artwork for use as textile designs. This involves generation of scaffolding using deterministic or geometric algorithms (e.g. generating grids, coordinate systems, motifs, tessellations, Voronoi cells, partitions, or any pattern) or user-provided silhouettes or images directly onto pattern pieces. It then utilizes a style transfer algorithm to apply style from user provided images onto the scaffolding on the pattern pieces.

In embodiments, the disclosure relates to an object-oriented visual programming system tailored for the purpose of procedurally generating designs on apparel in virtual environments. The virtual environment includes visual objects (e.g. formulas for geometric shapes or curves, user-provides images) and grids (e.g. curvilinear coordinate systems consisting of an origin within the bounds of the garment and any number of path segments, decompositions of the path segments' inner area into tessellations, branches that start on the path's edge and shoot off in the exterior direction). Visual objects and grid systems can be nested to procedurally draw fractals, culture-specific imagery, or virtually any pattern pieces. All logic can be created using a drag and drop editor and art canvas.

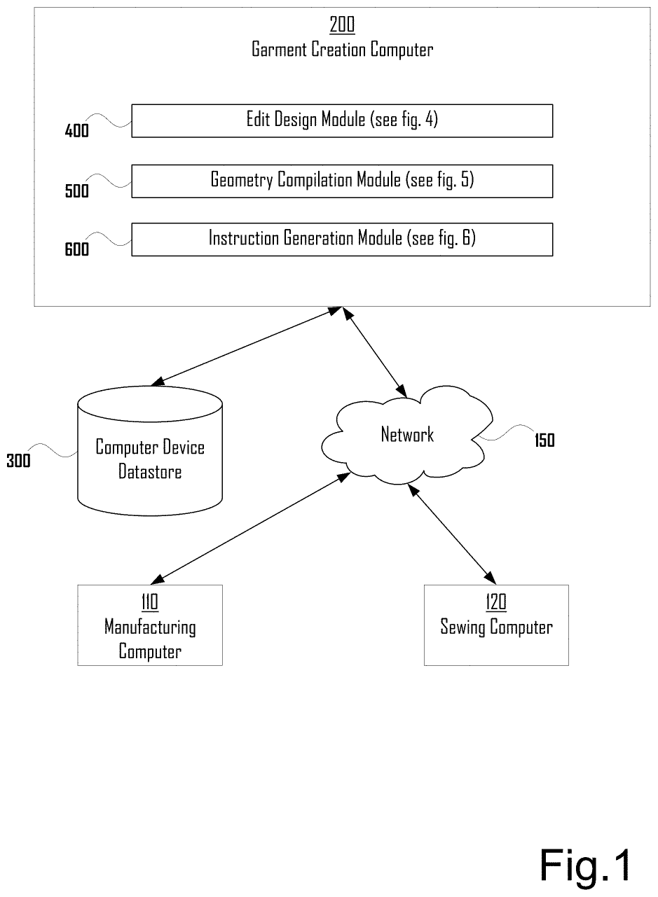

FIG. 1 is a network and device diagram illustrating an example of garment creation computer 200, computer device datastore 300, manufacturing computer 110, sewing computer 120 and network 150, according to some embodiments.

Garment creation computer 200 may comprise edit design module 400, geometry compilation module 500, and instruction generation module 600.

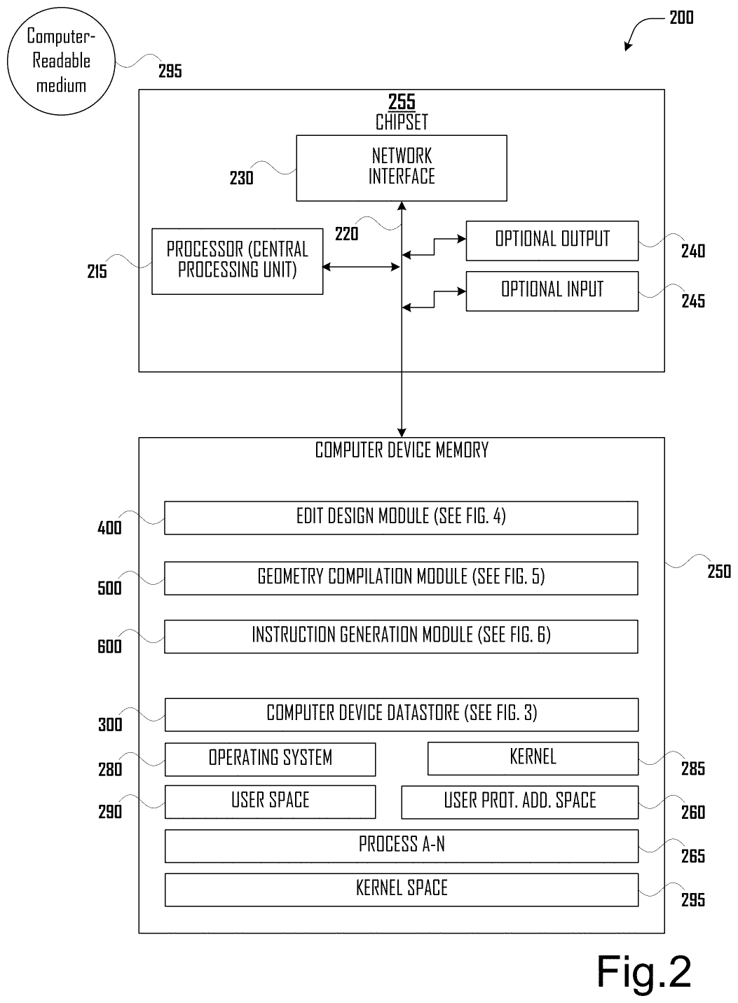

Manufacturing computer 110 and sewing computer 120 illustrated in FIG. 1 may be connected with network 150 and/or garment creation computer 200, described further in relation to FIG. 2.

Garment creation computer 200 is illustrated as connecting to computer device datastore 300. Computer device datastore 300 is described further, herein, though, generally, should be understood as a datastore used by garment creation computer 200.

Network 150 may comprise computers, network connections among the computers, and software routines to enable communication between the computers over the network connections. Examples of Network 150 comprise an Ethernet network, the Internet, and/or a wireless network, such as a GSM, TDMA, CDMA, EDGE, HSPA, LTE or other network provided by a wireless service provider. Connection to Network 150 may be via a Wi-Fi connection. More than one network may be involved in a communication session between the illustrated devices. Connection to Network 150 may require that the computers execute software routines which enable, for example, the seven layers of the OSI model of computer networking or equivalent in a wireless phone network.

FIG. 2 is a functional block diagram illustrating an example of garment creation computer 200, incorporated with teachings of the present disclosure, according to some embodiments. Garment creation computer 200 may include chipset 255. Chipset 255 may include processor 215, input/output (I/O) port(s) and peripheral devices, such as output 240 and input 245, and network interface 230, and computer device memory 250, all interconnected via bus 220. Network interface 230 may be utilized to form connections with network 150, with computer device datastore 300, or to form device-to-device connections with other computers.

Chipset 255 may include communication components and/or paths, e.g., buses 220, that couple processor 215 to peripheral devices, such as, for example, output 240 and input 245, which may be connected via I/O ports. Processor 215 may include one or more execution cores (CPUs). For example, chipset 255 may also include a peripheral controller hub (PCH) (not shown). In another example, chipset 255 may also include a sensors hub (not shown). Input 245 and output 240 may include, for example, user interface device(s) including a display, a touch-screen display, printer, keypad, keyboard, etc., sensor(s) including accelerometer, global positioning system (GPS), gyroscope, etc., communication logic, wired and/or wireless, storage device(s) including hard disk drives, solid-state drives, removable storage media, etc. I/O ports for input 245 and output 240 may be configured to transmit and/or receive commands and/or data according to one or more communications protocols. For example, one or more of the I/O ports may comply and/or be compatible with a universal serial bus (USB) protocol, peripheral component interconnect (PCI) protocol (e.g., PCI express (PCIe)), or the like.

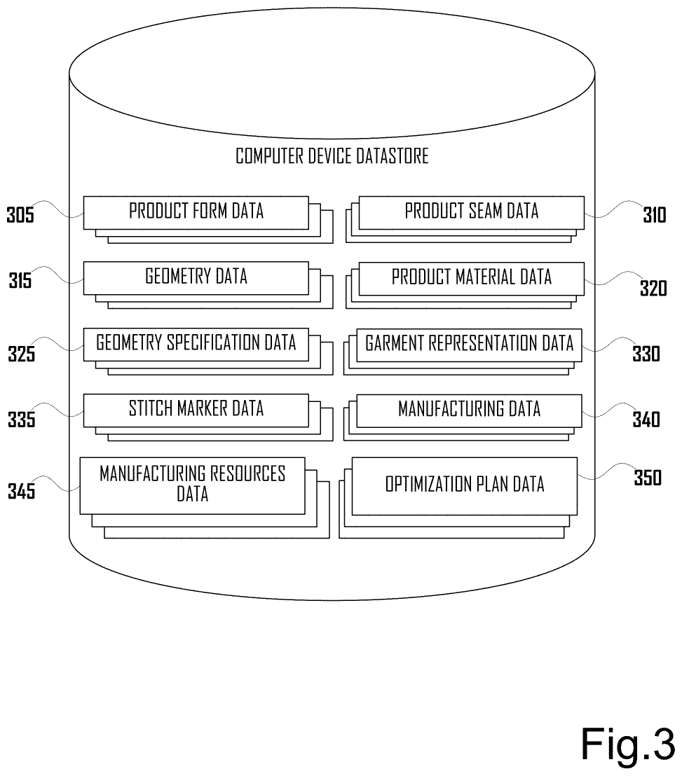

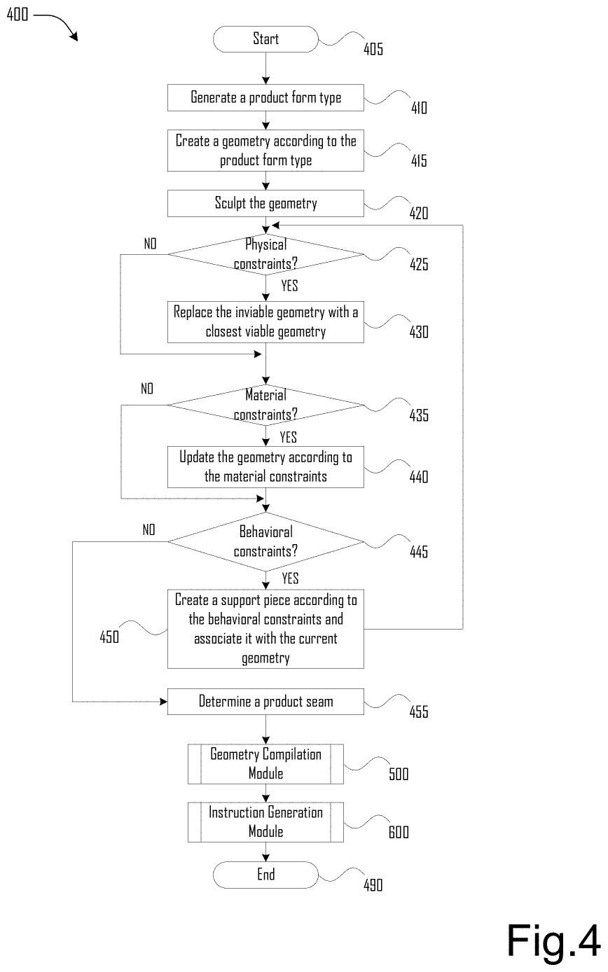

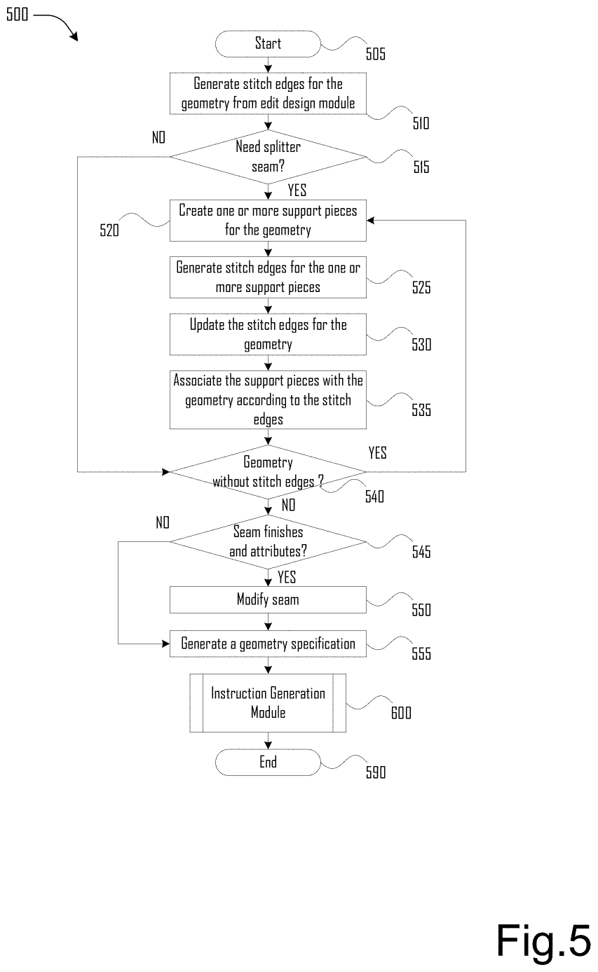

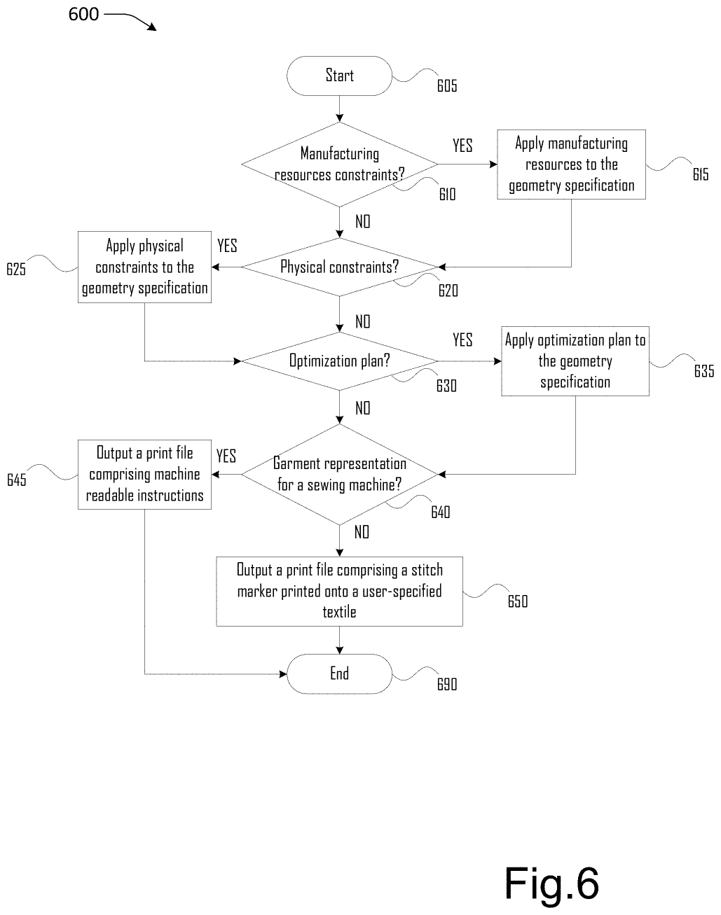

Computer device memory 250 may generally comprise a random-access memory (“RAM”), a read only memory (“ROM”), and a permanent mass storage device, such as a disk drive or SDRAM (synchronous dynamic random-access memory). Computer device memory 250 may store program code for modules and/or software routines, such as, for example, computer device datastore 300 (illustrated and discussed further in relation to FIG. 3), edit design module 400 (illustrated and discussed further in relation to FIG. 4), geometry compilation module 500 (illustrated and discussed further in relation to FIG. 5), instruction generation module 600 (illustrated and discussed further in relation to FIG. 6).

Computer device memory 250 may also store operating system 280. These software components may be loaded from a non-transient computer readable storage medium 295 into computer device memory 250 using a drive mechanism associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

Computer device memory 250 is also illustrated as comprising kernel 285, kernel space 295, user space 290, user protected address space 260, and computer device datastore 300 (illustrated and discussed further in relation to FIG. 3).

Computer device memory 250 may store one or more process 265 (i.e., executing software application(s)). Process 265 may be stored in user space 290. Process 265 may include one or more other process 265a . . . 265n. One or more process 265 may execute generally in parallel, i.e., as a plurality of processes and/or a plurality of threads.

Computer device memory 250 is further illustrated as storing operating system 280 and/or kernel 285. The operating system 280 and/or kernel 285 may be stored in kernel space 295. In some embodiments, operating system 280 may include kernel 285. Operating system 280 and/or kernel 285 may attempt to protect kernel space 295 and prevent access by certain of process 265a . . . 265n.

Kernel 285 may be configured to provide an interface between user processes and circuitry associated with garment creation computer 200. In other words, kernel 285 may be configured to manage access to processor 215, chipset 255, I/O ports and peripheral devices by process 265. Kernel 285 may include one or more drivers configured to manage and/or communicate with elements of garment creation computer 200 (i.e., processor 215, chipset 255, I/O ports and peripheral devices).

Garment creation computer 200 may also comprise or communicate via Bus 220 and/or network interface 230 with computer device datastore 300, illustrated and discussed further in relation to FIG. 3. In various embodiments, bus 220 may comprise a high-speed serial bus, and network interface 230 may be coupled to a storage area network (“SAN”), a high-speed wired or wireless network, and/or via other suitable communication technology. Garment creation computer 200 may, in some embodiments, include many more components than as illustrated. However, it is not necessary that all components be shown in order to disclose an illustrative embodiment.

FIG. 3 is a functional block diagram of the computer device datastore 300 illustrated in the computer device of FIG. 2, according to some embodiments. The components of computer device datastore 300 may include data groups used by modules and/or routines, e.g, product form data 305, product seam data 310, geometry data 315, product material data 320, geometry specification data 325, stitch marker data 335, manufacturing data 340, manufacturing resources data 345, optimization plan data 350 (to be described more fully below). The data groups used by modules or routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, references to other database entries, joins, conditional logic, tests, and similar.

The components of computer device datastore 300 are discussed further herein in the discussion of other of the Figures.

FIG. 4 is a flow diagram illustrating an example of edit design module 400, which may be performed by computer device(s), such as garment creation computer 200, according to some embodiments. In overview, edit design module 400 provides instructions to or call execution of geometry compilation module 500, wherein geometry compilation module 500 may further interface with instruction generation module 600. Together, edit design module 400, geometry compilation module 500 and instruction generation module 600 may be referred to as “product design module”.

At block 405, edit design module 400 may have a new user or customer, may be reviewing existing customers of edit design module 400, or may be preparing itself for new users or customers. A block 410, edit design module 400 may generate a product form type for a product form that may include user-defined input (user directive). The product form data may be stored in, for example, one or more product form data 305 records. If the product form type is started from scratch, edit design module 400 may define a mathematical space for a new product form type. Edit design module 400 may further define valid parametrizations of the product form type (e.g. a subset of a topological space, a vector field, a parametric surface with free variables corresponding to product parameters, a discrete finite set of product versions like named product variations). Products of the same type are often homeomorphic, which is a property that makes them suitable for editing in an organic modelling GUI. However, any system of rules including equalities, inequalities, sufficient conditions, necessary conditions, ratios and relations, and tests may define a product type. The product form type may be related to the general shape (silhouette) of a sewn product that a user wants. Edit design module 400 may provide product editing tools to facilitate the product form editing. If the product form type is subject to a fashion trend, aesthetic opinion, or any other subjective value judgements, edit design module 400 may set various subjective variables and configure an aesthetic module to associate these variables to the product form. Edit design module 400 may further define deformation information of the product form and map the user input to such deformation information.

At block 415, edit design module 400 may create a geometry according to the product form type. The geometry data may be stored in, for example, one or more geometry data 315 records. The geometry created may be a primitive scaffolding of a garment, or coarse shape of a garment piece (such as a left sleeve). Some parts of a product that are comprised of non-rigid pattern pieces (e.g. the cloth part of the garment) may be edited using direct modelling (e.g. editing the silhouette of a dress in the sculpting module) or parametric modelling (e.g. the user enters their body measurements, and the A-line dress gets re-sized to fit them). Markup editing is also good for refining coarse shapes made by parametric or direct modelling by letting the user add ruffles, folds, and other features to the overall silhouette. When working in a 2D environment, a geometry may be a parametrically defined path (e.g. Bezier curves). In a 3D environment, a geometry may be a faceted boundary representation (e.g. polygon mesh, most commonly a triangular mesh), topologically bound surfaces (NURBS, elementary surfaces like planes and cones) manifold or nonmanifold surface boundary representation, or any other representation of a surface.

At block 420, edit design module 400 may sculpt the geometry according to the product form type. The sculpting may be continuously deforming a virtual surface into homomorphic surfaces that satisfy product type definition with the new surface or changes in the surface bearing some causal relation to user input or changes in user input, stochatically or discretely generating isomorphisms that satisfy product type definition. Edit design module 400 may allow a real-time, continuously updating module that a user can directly manipulate. Edit design module 400 may add temporary markups to the geometry and later process the markups when a geometry specification is generated in geometry compilation module 500 (further illustrated in FIG. 5). These temporary markups may include folding markup indicating where and how intense the folds are on the garment. The geometry compilation module 500 may later process these markups to change the geometry of the garment pieces.

At block 425, edit design module 400 may determine whether there are physical constraints to the product form. Edit design module 400 may scan the geometry generated to check if there is a viable way to physically produce the current component of the product.

At block 430, if the geometry is determined inviable or physically impossible to produce, edit design module 400 may replace the inviable geometry with the closest viable geometry. Edit design module 400 may compose or decompose the geometry to create resulting viable geometry. Edit design module 400 may apply additional modifiers (such as aesthetic modifier) to re-adjust other constraints and relations still hold. Aesthetic modifiers may refer to functions that optimize the geometric boundary's compliance with arbitrary fashion industry standards, commonly agreed upon preferences, and visual or tactile aesthetic values (e.g. smoothing boundaries to optimize for a “clean” appearance, elongating the geometric boundary corresponding to the sleeve cap to optimize for a “fancy” appearance). Aesthetic modifiers may be useful for sensitive and conspicuous areas like sleeve cap, armhole seams, necklines, bust seams, and inseams (crotch area). For example, when 3D polygon meshes are flattened to 2D, the 3D polygon meshes will still be composed of straight-line segments, giving a jagged pointy appearance. This may be fine for shoulder seams but often not for princess seams, sleeve caps, armholes. Thus, an aesthetic modifier may be called to indicate that a spline must be drawn through these points to smooth out the edge. A user who knows that princess seams look best smooth, or an AI model with a semantic understanding of the garment specification and fashion trends/standards can classify the seam as a princess seam and classify sharp edges as unstylish in the context of a princess seam.

At block 435, edit design module 400 may determine whether there are material constraints to a product material. The product material data may be stored in, for example, one or more product material data 320 records. The product material may be selected by the user. The garment creation computer 200 may store material data that is applicable to a group of garments. To prevent invalid edits, garment creation computer 200 may preempt impossible product material choices by only letting the user to select what will work on the product design.

At block 440, edit design module 400 may update the geometry according to the material constraints. The garment creation computer 400 may take primitive 2D piece paths and output a high-fidelity 3D module of a garment that is simulated all the way down to the fiber level. Edit design module may apply transformations to the input to account for stretch, shrinkage, and other material properties that call for adjustments in the geometry specification.

In embodiments, different types of editing are available for a user or customer of edit design module 400. In various embodiments, there may be a user interface with buttons that say, “Edit product form”, “edit product seams”, and “edit product materials” that pop out sub-menus for editing.

The edit design module 400 may prevent a user from creating a “syntactically incorrect” outfit in the first place by constricting the range of the cursor movement so that it can only perform valid edits or pre-empting impossible material choices by only letting the user select what will work with the user's current geometry. An example interface of edit design module 400 may perform as a very strict Integrated Development Environment (IDE) that does not even register keystrokes that are not syntactically correct, such as a user cannot press enter without first putting a semicolon).

At block 445, edit design module 400 may determine whether there are behavioral constraints to the product material. As described herein, behavioral constraints may refer to how the product material may interact with the product form, and additional information that added to the product material, such as stiffness of a garment. For example, if a user wants to make a high-neck dress, the user may want to have the dress made from a comfortable material such as fluid silk satin. However, the comfortable material may make the collar of the dress look droopy and it is not what the user wants. Edit design module 400 may allow the user to have a stiff and structured collar by checking the behavioral constraints of the material.

At block 450, edit design module 400 may create a support piece according to the behavioral constraints and associate the support piece with the current geometry. As illustrated in the above example of making a high-neck dress, edit design module 400 may determine that the collar needs to have 8/10 stiffness. The current garment representation may show that the collar needs to be made from silk satin which is a 2/10 stiffness, yet the behavioral constraints show that the collar needs to be 8/10 stiffness. Edit design module 400 may automatically generate an additional support piece to meet the behavioral constraints, such as an interfacing or permanent stabilizer added to the collar. When creating a support piece, many factors are considered including the geometry and product material the support piece may interact with. For instance, edit design module 400 may thicken the silk used on the collar and determine using fusible interfacing would damage the collar so edit design module 400 may use sew-in interfacing. After generating the support piece, edit design module 400 may go back to check physical constraints at block 425 and material constraints at block 435 and make sure that the support piece is valid. This may be an iterative process, and some embodiments might allow user input as well.

At block 455, edit design module 400 may determine a product seam. The product seam data may be stored in, for example, one or more product seam data 310 records. For example, if a user has a prominent bust and wants a slim dress. Edit design module 400 may determine to add bust darts or curved seam markup to the geometry. Edit design module 400 may check for seams that will minimize area distortion of the sewn product. Geometry compilation module 500 may return to edit design module 400 to read the information form the product seam. Edit design module 400 may include a markup indicting a symmetrical garment with a product seam “stitch to midline”.

Edit design module 400 may further call for geometry compilation module 500, which is further illustrated in FIG. 5.

FIG. 5 is a flow diagram illustrating an example of a method performed by geometry compilation module 500, which may be performed by computer device(s), such as garment creation computer 200, according to some embodiments.

At block 510, geometry compilation module 500 may generate one or more stitch edges for the geometry generated from edit design module 400. The geometry compilation module 500 may read more information from the product form data 305, product seam data 310 and product material data 320 to check whether the stitch edges are valid and hold valid relations with other stitch edges. Stitch edges are high-level abstractions of segments along a product piece's boundary that may be sewn to another stitch edges, from which lower level adhesion tasks (e.g sewing, fusing, gluing, taping) and ultimately manufacturing instructions can be computed. The stitch edges may exist in pairs, where two geometries may be sewn together at the stitch edges to form a seam; the seam abstraction may later be compiled down into binary adhesion tasks. The geometry may have a single stitch edge that does not associate with any other stitch edges and can be assigned attributes in the product specification that later compile down to unary stitch edge tasks such as serging, overlocking, binding, applying trims, topstitching, or burning. A seam may also be an n-ary relation between n stitch edges, which may compile down into n-ary assembly tasks; an example of a seam that relates more than two stitch edges is zipper seams on a lined garment. In this example, three stitch edges must be sewn together: the lining material, outer material, and zipper tape. Each stitch edge may have a defined capacity of stitch edges that it can be associated with depending on attributes that it is assigned and the material that its enclosing surface is associated with. For example, a stitch edge assigned a “raw edge” finish has a capacity of exactly 0 stitch edge associations; a stitch edge on a denim piece may have a capacity of 1-3 associations, where more than 3 associations will be too bulky to sew. Capacities may also be conditional and trigger compiler action if the number of associations is above or below capacity (e.g. if a stitch edge has fewer than 1 associations, then assign the attribute “facing finish” to its specification, which will trigger a sequence of geometry generation and sewing to bring the stitch edge's associations back up to capacity). Geometry compilation module 500 may further check for this situation in block 540 as illustrated below.

At block 515, geometry compilation module 500 may determine whether there is a need for splitter seams. Multiple garment pieces may be joined together with a seam. Sometimes a product may not need seams. The geometry compilation module 500 may determine whether it would be impossible to sew the product without a proper seam. If seams are necessary, the geometry compilation module 500 may add seams to the geometry specification. Geometry compilation module 500 may create a seam type and define the form and behavior of the seam. In a typical example of a human sewing two fabric pieces together on a home sewing machine, a seam may encapsulate a set of stitches that are applied in a single pass without lifting the foot off the pedal, lifting the presser foot from the material, changing pieces, thread, or sewing settings.

Seam types may include splitter seams and appendage seams. Splitter seams may be referred to and classified as functional seams that may change the product's 3D shape or the silhouette of the garment. An example of a functional seam is a dart. Darts are a commonly occurring feature in sewing patterns that look like slices taken out of the overall shape; they give the garment a 3D shape and are most often used in clothing to accommodate curves on a human body; geometrically, darts approximate undevelopable surfaces by as a composition of conic surfaces. On the other hand, splitter seams may be referred to style lines that do not change the silhouette of the garment, but instead are an aesthetic flair. Seam settings can include abstract aesthetic data (e.g. piping, topstitching). For example, a user may want to split the dress geometry into front, side, and back panels. The seam lines between these pieces are splitter seams. However, the distinctions between a style line and a function seam are sometimes blurred.

Appendage seams may be referred to a type of seam that merges two geometries that are generated on different loops. One example of an appendage seam is a patch pocket added to a dress. A mesh dress geometry may have been sculpted and a square patch pocket geometry may have been generated. These two geometries may be made in two different environments using different tools. The seam that joins the square patch pocket geometry to the dress geometry to create a pocket may be referred as an appendage seam.

At block 520, geometry compilation module 500 may generate one or more support pieces for the geometry. The support pieces may be stored in the geometry data 315 records and/or the geometry specification data 325 records. Geometry compilation module 500 may call edit design module 400 to check physical constraints at block 425 and material constraints at block 435 and make sure that the support piece is valid.

At block 525, geometry compilation module 500 may generate one or more stitch edges for the one or more support pieces. The stitch edges for the support pieces may be stored in the geometry specification data 325 records.

At block 530, geometry compilation module 500 may update the one or more stitch edges for the geometry. The updated stitch edges for the geometry may be stored in the geometry specification data 325 records.

At block 535, geometry compilation module 500 may associate the one or more support pieces with the geometry according to the stitch edges.

At block 540, geometry compilation module 500 may determine whether there is geometry that does not have stitch edges. A geometry may have a side (i.e bounded sub-portion of the whole path) that does not have a stitch edge. The geometry compilation module 500 may detect the missing stitch edge by scanning the data stored in the geometry data 315 records and the geometry specification data 325 records.

At block 545, geometry compilation module 500 may determine whether there is seam finishes and attributes data stored in the seam form data 310 records. Product seam may be flagged with different attributes like “zipper closure”, “button closure” or abstract seam” (an abstract seam may be two or more stitch edges that must maintain a particular relation to one another, but do not necessarily need to be physically adhered or otherwise forced in proximity to one another; an example of an abstract seam may include the two opposite edges of a printed high-slit skirt, where the two stitch edges are not ever joined but any prints that continue across the abstract seam should line up). Geometry compilation module 500 may determine the tension between seams and how precisely the seam must approximate trace of the geometry. Visible seam finishes may be used as a reinforcement tool to improve durability, but they may also contribute to the aesthetic appeal of a garment. For example, topstitching can sometimes be used for functional reasons to make leather seams stay flat, in which case geometry compilation module 500 may recommend a seam finish. A user may also define how the topstitching looks like.

At block 550, geometry compilation module 500 may modify seam of the geometry according to the seam finishes and attributes stored in the seam form data 310 records. Geometry compilation module 500 may add extra seams to meet geometry constraints. Geometry compilation module 500 may call edit design module 400 to validate the extra seams to meet fidelity constraints (e.g. angle distortion, area distortion tolerance limits). For example, the geometry and its symmetric counterpart cannot be manufactured without significant distortion. The addition of seams may help accommodate the curve to allow the garment to be manufactured with less distortion. Optionally, geometry compilation module 500 may apply additional modifiers (such as a style modifier) to find the most trendy or aesthetically optimal seam placement to recommend modification on the seams.

At block 555, geometry compilation module 500 may generate geometry specification. Geometry compilation module 500 may translate the temporary markups generated in edit design module 400 into a technically accurate specification. Geometry compilation module 500 may break a 3D shape into appropriate primitive shapes based on product seams and feature maps, which may be referred to as segmentation or in the case of segmentation down to 2D pieces, flattening. Geometry compilation module 500 may figure out which parts of the original piece now belong to which new pieces that it was broken down to, and update seam relationships between other pieces. Geometry compilation module 500 may further refine the geometry with details such as adding draw vertical lines on a skirt with the pleat tool, drawing swooping horizontal lines below the neck to turn a boat neck into a cowl neck.

At block 590, geometry compilation module 500 may conclude and/or return to edit design module 400 and/or enter instruction generation module 600 (further illustrated in FIG. 6).

FIG. 6 is a flow diagram illustrating an example of a method performed by instruction generation module 600, which may be performed by computer device(s), such as garment creation computer 200, according to some embodiments.

At block 610, instruction generation module 600 may determine whether there are manufacturing resources constraints. The manufacturing resources constraints may be stored in the manufacturing resources data 345 records.

At block 615, instruction generation module 600 may apply manufacturing resources constraints to the geometry specification. Instruction generation module 600 may determine means of input that each manufacturing resource will accept. A map of manufacturing resources to means of input and associated metadata is produced.

At block 620, instruction generation module 600 may determine whether there are physical constraints. There may be physical dependency graph of routine tasks, such as common predictable units of human labor, a single or cut print job, a single outsourcing contract.

At block 625, instruction generation module 600 may apply the physical constraints to the geometry specification. Instruction generation module 600 may generate alternate versions of routine execution flows (e.g. different orders to do it, different ways to parallelize). Instruction generation module 600 may determine “meta-routines” that needed to make instructions (e.g. routines involved printing instruction manuals out). Instruction generation module 600 may map physical execute plan to a cost or effect analysis.

At block 630, instruction generation module 600 may determine whether there is an optimization plan stored in the optimization plan data 350 records. The optimization plan may comprise optimization for minimizing carbon emissions, saving time or money.

At block 635, instruction generation module 600 may apply the optimization plan to the geometry specification. Instruction generation module 600 may determine the optimized order of routines, such as which form of input to send to each manufacturing resource.

At block 640, instruction generation module 600 may determine whether the garment representation is generated for a sewing machine. Instruction generation module 600 may generate garment representation for a sewing machine to construct the sewn product, or stitch markers for a user to sew the product.

At block 645, instruction generation module 600 may output a print file comprising machine readable instructions for a sewing machine to construct the sewn product. Instruction generation module 600 may generate machine-readable instructions and/or fiducial markers for a closed-loop robotic sewing of a soft good. The machine-readable instructions and fiducial markers may be stored in the manufacturing data 340 records. A sewing robot may utilize computer vision to determine material position by tracking incremental movements and avoid accumulation of error by also tracking the fiducial markers. The addition of information given by detecting the fiducial markers will drastically improve a machine's ability to accurately estimate the fabric's global position. More computationally efficient algorithms and less expensive sensors can be used to achieve highly accurate sensing of the annotated fabric.

In embodiments, the machine readable instructions may include instructions for a sewing robot programed under a numerical control (CNC) programming language, such as G-code. The garment creation computer 200 may generate dynamic instructions for a robot starting with a prior set of instructions be similar to the static machine code generated for an open-loop CNC sewing robot. This is a-priori instruction set is the default instruction set that the sewing robot will follow in the absence of sensor feedback. The garment creation computer 200 may also generate instructions for a closed-loop manufacturing system that executes the prior instruction set but modifies these instructions during runtime by inputting sensory feedback pertaining to the fiducial markers in a sensor processing algorithm to infer state (e.g. a Kalman filter) and running a decision-making algorithm to determine changes needed to existing execution plan. For example, a robotic arm may move a piece of silk too short of a distance because the silk's natural irregularities made it slippery in the spot that it was grasped. A sensor may detect this by noticing that the fiducial markers are 2 millimeters off from their expected positions. The robot's instructions may be modified to request the robotic arm to the move the silk forward an extra 2 millimeters. It is a more computationally and cost-efficient way to keep track of the fiducial marker than compared to relying on accurate sensing of an unmarked material's texture (e.g. fiber) and other features that vary highly from material to material and are difficult to discern.

At block 650, instruction generation module 600 may output a print file comprising a stitch marker printed onto a user-specified textile. The stitch marker may be stored in the stitch marker data 335 records. Instruction generation module 600 may also output sewing instructions stored in the manufacturing data 340 records. A user may manually sew custom physical garment with stitch marker printed on the textile and sewing instructions.

The stitch markers are positioned near the seams of the garment, typically on the seam allowance. A stitch marker may have a shape or a path that intersects with the seam line at a point where a needle needs to be inserted to sew the garment. The stitch markers may have symbols that identify each marker. These symbols can take many forms, and the symbol system can be organized using many different schemas (e.g. a letter represents a unique continuous edge, and the subsequent number represents the index of the marker along that edge)

In embodiments, at block 645 and 650, instruction generation module 600 may output an “effect summary” along with the print file. The effect summary may be stored in the manufacturing data 340 records. Effect summary is a catch-all phrase to describe consequences of manufacturing such as how much making the product in this way will cost, how much energy will be involved, carbon footprint, water use, basically any resource use, effects on laborers, any damage it could cause to an asset, potential certifications/warnings that the product could trigger. Though these are side-effects, they will be important factors in determining whether the computed manufacturing strategy is any good, and if it is better than the rest. Another class of effect in the summary will be perversions, i.e. tweaks reflected in the instruction set that deviate from the pure user specifications. In the scenario of high perversion, decompiling the instruction set back to a product specification may result in a product quite different from the original. This happens because most manufacturing resources cannot complete the exact task asked but can make a good approximation. For example, some XY pen plotters cannot move along Bezier curves, and instead move across a linear approximation of Bezier curves. Most printers do not print gradients but generate a rasterized approximation of one. Even on screens, fragment shaders are eventually rasterized. Most of these small perversions are unnoticeable and acceptable, but sometimes they can add up, which this comparison process minimizes.

At block 690, instruction generation module 600 may conclude and/or return to another module and/or another process which may have spawned or called it.

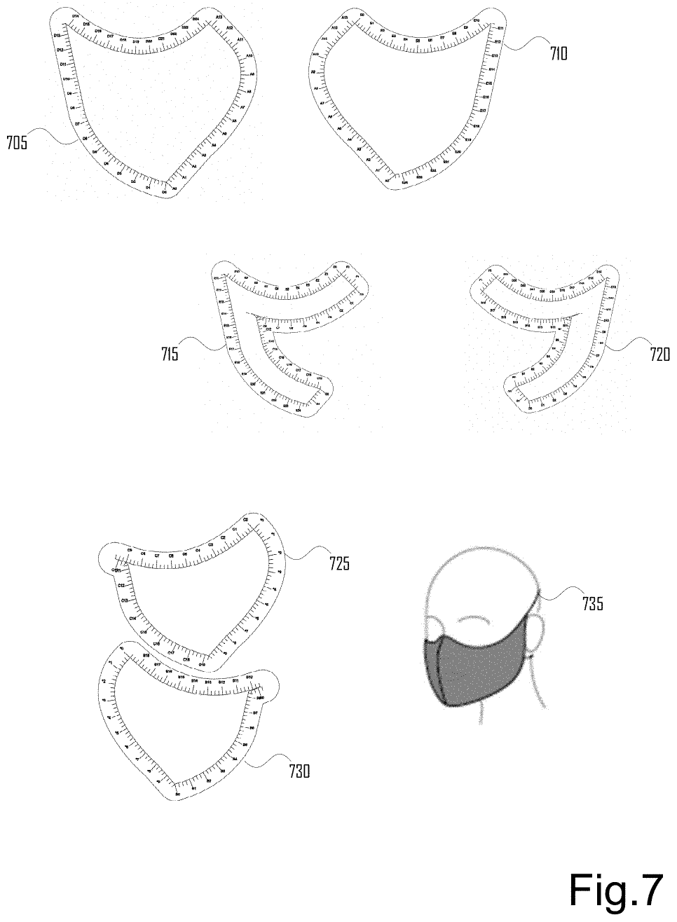

FIG. 7 is a diagram illustrating an example of a method performed by garment creation computer 200, which may be performed by computer device(s), such as manufacturing computer 110 and sewing computer 120, according to some embodiments.

A user may want to make a mask by the user's own design and measurements. Garment creation computer 200 may comprise a computer processor and a memory, and the memory may comprise a product design module to generate a garment representation for the mask. Garment creation computer 200 may cause the computer process to call edit design module 400 to determine product form, determine product material and determine product seam for the garment representation for the mask. For example, cotton may be selected as the manufacturing fabric and pinked is selected as seam finish. Garment creation computer 200 may further cause the computer process to call geometry compilation module 500 to generate a geometry specification according to the product form, product material and product seam for the garment representation for the mask. Garment creation computer 200 may further cause the computer process to call instruction generation module 600 to output the garment representation as a stitch marker printed onto the textile that the user specified. If garment creation computer 200 is working with other computer devices, such as a sewing machine, garment creation computer 200 may cause the computer process to call instruction generation module 600 to output the garment representation as machine readable instructions for the sewing machine to construct the mask.

Garment creation computer 200 may generate six garment pieces: left side of the outward facing part of the mask (705), right side of the outward facing part of the mask (710), the right side of the inward facing part of the mask (715), the left side of the inward facing part of the mask (720), right inside lining piece (725), and left inside lining piece (730). 735 is an example illustration of when the six garment pieces are sewn together.

The garment representation of the mask is outputted as stitch markers printed on the garment pieces 705-725. The stitch markers may include numbers, letters, and symbols for sewing. For example, one edge of 705 may be marked from A0 to A14 and one edge of 710 may be also marked from A0 to A14. That means these two edges need to be sewn together. The stitch markers may include notches that help the user to line up the markers. For outer pieces (e.g. 705 and 710), the side with the notches will face the user and the notches will be hidden in the final mask. For inner pieces (e.g. 715 and 720) and lining pieces (e.g. 725 and 730), the side with the notches will face away the user and the notches will be hidden in the final mask.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions. USB (Universal serial bus) may comply or be compatible with Universal Serial Bus Specification, Revision 2.0, published by the Universal Serial Bus organization, Apr. 27, 2000, and/or later versions of this specification, for example, Universal Serial Bus Specification, Revision 3.1, published Jul. 26, 2013. PCIe may comply or be compatible with PCI Express 3.0 Base specification, Revision 3.0, published by Peripheral Component Interconnect Special Interest Group (PCI-SIG), November 2010, and/or later and/or related versions of this specification.

“Circuitry”, as used in any embodiment herein, may comprise, for example, singly or in any combination, hardwired circuitry, programmable circuitry such as FPGA. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Following are non-limiting examples of embodiments of the disclosure herein:

Example 1. An apparatus to generate a garment representation for a sewn product, comprising: a computer processor and a memory; wherein the memory comprises a product design module; wherein the computer processor is to execute the product design module to generate the garment representation for the sewn product; wherein to generate the garment representation for the sewn product, the product design module is to cause the processor to determine a product form, create a geometry according to the product form, determine a product seam, determine a product material, generate a geometry specification for the sewn product according to the product form, the product seam, and the product material, and to output the garment representation as a print file.

Example 2. The apparatus according to one or more of Example 1 or another example herein, wherein to create the geometry according to the product form, the product design module is to generate a product form type and sculpt the geometry according to the product form type.

Example 3. The apparatus according to one or more of Example 2 or another example herein, wherein the product design module is further to analyze physical constraints of the product form and replace the geometry with a closest viable geometry according to the physical constraints of the product form.

Example 4. The apparatus according to one or more of Example 1 or another example herein, wherein to determine the product material, the product design module is to analyze material constraints of the product material and update the geometry according to the material constraints of the product material.

Example 5. The apparatus according to one or more of Example 4 or another example herein, wherein the product design module is further to analyze behavioral constraints of the geometry and create a support piece according to the behavioral constraints of the geometry and associate the support piece to the geometry.

Example 6. The apparatus according to one or more of Example 1 or another example herein claim 2, wherein to generate the geometry specification, the product design module is to generate one or more stitch edges for the geometry.

Example 7. The apparatus according to one or more of Example 6 or another example herein, wherein the product design module is further to create one or more support pieces.

Example 8. The apparatus according to one or more of Example 7 or another example herein, wherein the product design module is further to generate one or more stitch edges for each of the one or more support pieces.

Example 9. The apparatus according to one or more of Example 8 or another example herein, wherein the product design module is further to associate the one or more support pieces with the geometry according to the one or more stitch edges.

Example 10. The apparatus according to one or more of Example 6 or another example herein, wherein the product design module is further to determine seam finishes and seam attributes for the geometry and modify the seam.

Example 11. The apparatus according to one or more of Example 4 or another example herein, wherein to analyze the material constraints of the geometry, the product design module is to analyze a material property comprising at least one of a grain, a knit pattern, an elasticity, a thread count, a flammability, a tensile strength, or a permeability.

Example 12. The apparatus according to one or more of Example 1 or another example herein, wherein to output the garment representation as the print file, the product design module is to output the print file comprising a stitch marker printed onto a user-specified textile.

Example 13. The apparatus according to one or more of Example 1 or another example herein, wherein to output the garment representation as the print file, the product design module is to output the print file comprising machine readable instructions to cause a sewing machine to construct the sewn product.

Example 14. A computer implemented method for generating a garment representation for a sewn product, comprising: determining a product form, creating a geometry according to the product form, determining a product seam, determining a product material, generating a geometry specification for the sewn product according to the product form, the product seam, and the product material, and outputting the garment representation as a print file.

Example 15. The method according to one or more of Example 14 or another example herein, wherein creating the geometry according to the product form comprises generating a product form type and sculpt the geometry according to the product form type.

Example 16. The method according to one or more of Example 15 or another example herein, further comprises analyzing physical constraints of the product form and replacing the geometry with a closest viable geometry according to the physical constraints of the product form.

Example 17. The method according to one or more of Example 14 or another example herein, wherein determining the product material comprises analyzing material constraints of the geometry and updating the geometry according to the material constraints of the geometry.

Example 18. The method according to one or more of Example 17 or another example herein, further comprises analyzing behavioral constraints of the product material and creating a support piece according to the behavioral constraints of the product material and associating the support piece to the geometry.

Example 19. The method according to one or more of Example 14 or another example herein, wherein generating the geometry specification further comprises creating one or more stitch edges for the geometry.

Example 20. The method according to one or more of Example 19 or another example herein, further comprises creating one or more support pieces.

Example 21. The method according to one or more of Example 20 or another example herein, further comprises generating one or more stitch edges for each of the one or more support pieces and updating the one or more stitch edges for the geometry.

Example 22. The method according to one or more of Example 21 or another example herein, further comprises associating the one or more support pieces with the geometry according to the one or more stitch edges.

Example 23. The method according to one or more of Example 19 or another example herein, further comprises determining seam finishes for the geometry and modify the seam.

Example 24. The method according to one or more of Example 17 or another example herein, wherein analyzing the material constraints of the geometry comprises analyzing a material property comprising at least one of a grain, a knit pattern, an elasticity, a thread count, a flammability, a tensile strength, or a permeability.

Example 25. The method according to one or more of Example 14 or another example herein, wherein outputting the garment representation as the print file comprises outputting the print file comprising a stitch marker printed onto a user-specified textile.

Example 26. The method according to one or more of Example 14 or another example herein, wherein outputting the garment representation as the print file comprises outputting the print file comprising machine readable instructions to cause a sewing machine to construct the sewn product.

Example 27. One or more computer-readable media comprising instructions that cause at least one computer device, in response to execution of the instructions by a processor of the at least one computer device, to: generate the garment representation for the sewn product, wherein in the generated garment representation for the sewn product, the computer-readable media further comprise instructions that cause the computer device, in response to execution of the instructions by the processor of the computer device, to determine a product form, create a geometry according to the product form, determine a product seam, determine a product material, generate a geometry specification for the sewn product according to the product form, the product seam, and the product material, and to output the garment representation as a print file.

Example 28. The computer-readable media according to one or more of Example 27 or another example herein, wherein to create the geometry according to the product form, the instructions further cause at least one computer device to generate a product form type and sculpt the geometry according to the product form type.

Example 29. The computer-readable media according to one or more of Example 28 or another example herein, wherein the instructions further cause at least one computer device to analyze physical constraints of the product form and replace the geometry with a closest viable geometry according to the physical constraints of the product form.

Example 30. The computer-readable media according to one or more of Example 27 or another example herein, wherein to determine the product material, the instructions further cause at least one computer device to analyze material constraints of the geometry and update the geometry according to the material constraints of the geometry.

Example 31. The apparatus according to one or more of Example 30 or another example herein, wherein the instructions further cause at least one computer device to analyze behavioral constraints of the product material and create a support piece according to the behavioral constraints of the product material and associate the support piece to the geometry.

Example 32. The apparatus according to one or more of Example 27 or another example herein, wherein to generate the geometry specification, the instructions further cause at least one computer device to create one or more stitch edges for the geometry.

Example 33. The apparatus according to one or more of Example 32 or another example herein claim 5, wherein the instructions further cause at least one computer device to create one or more support pieces.

Example 34. The apparatus according to one or more of Example 33 or another example herein, wherein the instructions further cause at least one computer device to generate one or more stitch edges for each of the one or more support pieces and update the one or more stitch edges for the geometry.

Example 35. The apparatus according to one or more of Example 34 or another example herein, wherein the instructions further cause at least one computer device to associate the one or more support pieces with the geometry according to the one or more stitch edges.

Example 36. The apparatus according to one or more of Example 32 or another example herein, wherein the instructions further cause at least one computer device to determine seam finishes and seam attributes for the geometry and modify the seam.

Example 37. The apparatus according to one or more of Example 30 or another example herein, wherein to analyze the material constraints of the geometry, the instructions further cause at least one computer device to analyze a material property comprising at least one of a grain, a knit pattern, an elasticity, a thread count, a flammability, a tensile strength, or a permeability.

Example 38. The apparatus according to one or more of Example 27 or another example herein, wherein to output the garment representation as the print file, the instructions further cause at least one computer device to output the print file comprising a stitch marker printed onto a user-specified textile.

Example 39. The apparatus according to one or more of Example 27 or another example herein 0, wherein to output the garment representation as the print file, the instructions further cause at least one computer device to output the print file comprising machine readable instructions to cause a sewing machine to construct the sewn product.

1. An apparatus to generate a garment representation for a sewn product, comprising:
a computer processor and a memory;
wherein the memory comprises a product design module;
wherein the computer processor is to execute the product design module to generate the garment representation for the sewn product;
wherein to generate the garment representation for the sewn product, the product design module is to cause the processor to determine a product form, create a geometry according to the product form, determine a product seam, determine a product material, generate a geometry specification for the sewn product according to the product form, the product seam, and the product material, and to output the garment representation as a print file.

2. The apparatus according to claim 1, wherein to create the geometry according to the product form, the product design module is to generate a product form type, sculpt the geometry according to the product form type, analyze physical constraints of the product form and replace the geometry with a closest viable geometry according to the physical constraints of the product form.

3. The apparatus according to claim 1, wherein to determine the product material, the product design module is to analyze material constraints of the product material and update the geometry according to the material constraints of the product material, wherein to analyze the material constraints of the product material the product design module is to analyze a material property comprising at least one of a grain, a knit pattern, an elasticity, a thread count, a flammability, a tensile strength, or a permeability.

4. The apparatus according to claim 3, wherein the product design module is further to analyze behavioral constraints of the product material and create a support piece according to the behavioral constraints of the product material and associate the support piece with the geometry.

5. The apparatus according to claim 1, wherein to generate the geometry specification, the product design module is to generate one or more stitch edges for the geometry, determine seam finishes and seam attributes for the geometry and modify the seam.

6. The apparatus according to claim 5, wherein to generate the one or more stitch edge for the geometry, the product design module is further to create one or more support pieces, generate one or more stitch edges for each of the one or more support pieces, update the one or more stitch edges for the geometry, and associate the one or more support pieces with the geometry according to the one or more stitch edges.

7. The apparatus according to claim 1, wherein to output the garment representation as the print file, the product design module is to output the print file comprising a stitch marker printed onto a user-specified textile.

8. The apparatus according to claim 1, wherein to output the garment representation as the print file, the product design module is to output the print file comprising machine readable instructions to cause a sewing machine to construct the sewn product.

9. A computer implemented method for generating a garment representation for a sewn product, comprising:
determining a product form;
creating a geometry according to the product form;
determining a product seam;
determining a product material;
generating a geometry specification for the sewn product according to the product form, the product seam, and the product material; and
outputting the garment representation as a print file.

10. The method according to claim 9, wherein creating the geometry according to the product form comprises generating a product form type and sculpt the geometry according to the product form type, analyzing physical constraints of the product form and replacing the geometry with a closest viable geometry according to the physical constraints of the product form.

11. The method according to claim 9, wherein determining the product material comprises analyzing material constraints of the product material and updating the geometry according to the material constraints of the product material, wherein analyzing the material constraints of the product material comprises analyzing a material property comprising at least one of a grain, a knit pattern, an elasticity, a thread count, a flammability, a tensile strength, or a permeability.

12. The method according to claim 11, further comprises analyzing behavioral constraints of the product material, creating a support piece according to the behavioral constraints of the product material and associating the support piece to the geometry.

13. The method according to claim 9, wherein generating the geometry specification comprises generating one or more stitch edges for the geometry, determining seam finishes and seam attributes for the geometry, and modifying the seam.

14. The method according to claim 13, wherein generating the one or more stitch edge for the geometry comprises creating one or more support pieces, generating one or more stitch edges for each of the one or more support pieces, updating the one or more stitch edges for the geometry, and associating the one or more support pieces with the geometry according to the one or more stitch edges.

15. The method according to claim 9, wherein outputting the garment representation as the print file comprises outputting the print file comprising a stitch marker printed onto a user-specified textile and machine readable instructions to cause a sewing machine to construct the sewn product.

16. One or more computer-readable media comprising instructions that cause at least one computer device, in response to execution of the instructions by a processor of the at least one computer device, to:
generate the garment representation for the sewn product;
wherein in the generated garment representation for the sewn product, the computer-readable media further comprise instructions that cause the computer device, in response to execution of the instructions by the processor of the computer device, to determine a product form, create a geometry according to the product form, determine a product seam, determine a product material, generate a geometry specification for the sewn product according to the product form, the product seam, and the product material, and to output the garment representation as a print file.

17. The computer-readable media according to claim 16, wherein to create the geometry according to the product form, the instructions further cause at least one computer device to generate a product form type, sculpt the geometry according to the product form type, analyze physical constraints of the product form and replace the geometry with a closest viable geometry according to the physical constraints of the product form.

18. The computer-readable media according to claim 16, wherein to determine the product material, the instructions further cause at least one computer device to analyze material constraints and behavioral constraints of the product material, update the geometry according to the material constraints of the product material, create a support piece according to the behavioral constraints of the product material and associate the support piece to the geometry.

19. The apparatus according to claim 16, wherein to generate the geometry specification, the instructions further cause at least one computer device to generate one or more stitch edges for the geometry, create one or more support pieces, generate one or more stitch edges for each of the one or more support pieces, update the one or more stitch edges for the geometry, and associate the one or more support pieces with the geometry according to the one or more stitch edges.

20. The apparatus according to claim 16, wherein to output the garment representation as the print file, the instructions further cause at least one computer device to output the print file comprising a stitch marker printed onto a user-specified textile and machine readable instructions to cause a sewing machine to construct the sewn product.
